(19) United States
(12) Patent Application Publication
(10) Pub. No.: US 2016/0203220 A1
(43) Pub. Date: Jul. 14, 2016

(54) METHOD AND APPARATUS FOR NATURAL LANGUAGE SEARCHING BASED ON MCCS

(71) Applicant: Bank of America Corporation, Charlotte, NC (US)

(72) Inventors: Viju Kothuvatiparambil, Seattle, WA (US); Stephen L. Yaeger, Seattle, WA (US); Marco A. Ramirez, Burien, WA (US); Ramakrishna R. Yannam, Seattle, WA (US); David H. Witting, Puyallup, WA (US)

(21) Appl. No.: 14/595,279

(22) Filed: Jan. 13, 2015

(51) Int. Cl. G06F 17/30; G06Q 10/10

(52) U.S. Cl. CPC G06F 17/30864; G06Q 10/10; G06F 17/3043; G06F 17/30401; G06F 17/30011; G06F 17/30528

(57) ABSTRACT

Apparatus, including a processor, for performing a search based, at least in part, on MCC information, is provided. The processor may identify an MCC with greater than a threshold level of correlation to a user's query. The processor may be configured to search a machine-readable memory for documents pertaining to the MCC and/or pertaining to the user's query. The processor may respond to the user's query by providing a set of documents. The processor may provide a reciprocal query. The reciprocal query may be for obtaining a greater quantum of MCC information then was included in the user's query. The reciprocal query may prompt the user to choose from one or more of a plurality of MCCs that correlate to the subject matter area. The reciprocal query may prompt a user to select from a plurality of subject matter areas corresponding to the plurality of MCCs.

### FIELD OF TECHNOLOGY

This invention relates to Merchant Category Codes (“MCC”). More specifically, this invention relates to searching based on MCCs.

### BACKGROUND OF THE DISCLOSURE

Conventional search functions enable a user to input one or more terms to define a query. Such terms typically provide a basis for determining a selection from a group of target documents.

Such target documents are typically stored in databases. A database, for the purpose of this application, may be understood to be a structured set of data held in a computer, especially one that is accessible in various ways; (Oxford Dictionaries, (online ed. 2014) (defining “database”)); see, also, Merriam-Webster's Collegiate Dictionary, (11th ed. 2012) (defining “database” as a collection of pieces of information that is organized and used on a computer).

It would be desirable to draw on certain heretofore unavailable stores of information in order to provide the most accurate document retrieval algorithms and, therefore, to enhance the user searching experience.

It would be yet further desirable to more accurately tune the document retrieval algorithms to more quickly arrive at a highly desired selection of query results.

### SUMMARY OF THE DISCLOSURE

A method for executing a search based on merchant category codes (“MCC”) codes is provided. The method may include providing a webpage comprising a search box. The search box may include a user input field. In response to receipt of a user query into the user input field, the method may include using a processor to identify a subject matter area. The subject matter area may correlate to a plurality of MCCs at a greater than threshold level of correlation. In response to identifying the subject matter area, the processor may be further configured to search a machine-readable memory for documents pertaining to the subject matter area and pertaining to the user's query. The processor may also be configured to provide a set of documents that respond to the user's query. In some embodiments, the method may also include prompting the user to identify a single MCC from among the plurality of MCCs. The single MCC may correspond more closely to the user's query than the other members of the plurality of MCCs. The prompting may include using the processor to provide a reciprocal query to the user. The reciprocal query may provides the plurality of MCCs, or subject matter corresponding to the plurality of MCCs, to the user in order to prompt the user to self-identify the MCC most closely related to the user's query.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative apparatus in accordance with principles of the invention;

FIG. 2 shows an illustrative apparatus in accordance with the principles of the invention;

FIG. 3 shows an illustrative hybrid apparatus/flow diagram according to certain embodiments;

FIG. 4 shows a unified modeling language (“UML”) visualization of embodiments according to the invention;

FIG. 5 shows an illustrative flow diagram in accordance with the principles of the invention;

FIG. 6 shows another illustrative flow diagram in accordance with the principles of the invention;

FIG. 7 shows yet another illustrative flow diagram accordance with the principles of the invention; and

FIG. 8 shows an illustrative chart showing additional detail for understanding the information set forth in FIG. 7.

### DETAILED DESCRIPTION OF THE DISCLOSURE

Apparatus and methods for natural language ontology/dictionary searching based on merchant category codes (“MCC”) are provided.

In order to better understand the embodiments set forth herein, an introduction to MCC is provided below.

An MCC may classify a transaction participant based on a primary line of business. For example, a merchant may be assigned an MCC based on whether the merchant provides predominately goods or provides predominately services. If a merchant provides both goods and services, an MCC assigned to the merchant may correspond to the majority of the merchant's business.

An MCC may classify a transaction participant based on a market segment serviced by the merchant. An MCC may be associated with a taxation status. Exemplary MCCs and associated market segments are shown below in Table 1.

TABLE 1

| Illustrative Merchant Category Code | Illustrative Associated Market |
|---|---|
| (“MCC”) | Segment |
| 0742 | Veterinary Services |
| 4214 | Motor Freight Carriers and |
| | Trucking - Local and Long |
| | Distance, Moving and Storage |
| | Companies, and Local Delivery |
| | Services |
| 4812 | Telecommunication Equipment and |
| | Telephone Sales |
| 5047 | Medical, Dental, Ophthalmic, |
| | Hospital Equipment and Supplies |
| 5172 | Petroleum and Petroleum |
| | Products |
| 5718 | Fireplace, Fireplace Screens, |
| | and Accessories Stores |

An MCC may be assigned by a transaction acquirer—such as a financial institution who services the credit card and debit card transactions of a merchant. The acquirer may assign the MCC to a merchant at a time the merchant agrees to accept a pre-determined payment instrument as a form of payment.

A merchant may be assigned multiple MCCs. For example, the merchant may provide pharmacy products and grocery products. The pharmacy products may be assigned a first MCC and the grocery products may be assigned a second MCC.

The MCC may be a transaction attribute. For example, the merchant may provide predominately pharmacy products at a first location and predominately grocery products at a second location. A transaction that occurs at the first location may be associated with the first MCC. A transaction that occurs at the second location may be associated with the second MCC.

As a further example, the merchant may house a pharmacy and a grocery at a single address. The pharmacy may be associated with a first POS location and the grocery may be associated with a second POS location. Purchases made at the first POS location may be associated with the first MCC and purchases made at the second POS location may be associated with the second MCC.

Embodiments of apparatus for executing a search based on merchant category codes (“MCC”) codes are provided. Certain embodiments may include a webpage. The webpage may include a search box. The search box may include a user input field.

In certain embodiments, when a user types a query into the user input field, the processor may be configured to identify an MCC with greater than a threshold level of correlation to the user's query. In response to identifying the MCC, the apparatus may be configured to search the machine-readable memory for documents pertaining to the MCC and pertaining to the user's query.

The processor may be further configured to provide a set of documents in response to the user's query. In addition, the processor may be configured to provide a reciprocal query to the user. The reciprocal query may be for obtaining a greater quantum of MCC information then was included in the user's query.

In some embodiments, when a user types a query into the user input field, the processor may be configured to identify a subject matter area. The subject matter area may correlate to a plurality of MCCs at a greater than threshold level of correlation.

In response to identifying the subject matter area, the processor may be further configured to search the machine-readable memory for documents pertaining to the subject matter area and pertaining to the user's query. The processor may be configured to provide a set of documents that respond to the user's query.

The processor may be further configured to provide a reciprocal query to the user. The reciprocal query may prompt the user to choose from one or more of the plurality of MCCs that correlate to the subject matter area. The reciprocal query may prompt a user to select from a plurality of subject matter areas corresponding to the plurality of MCCs. Such prompting may preferably encourage a user to identify one or more MCCs corresponding to the user's query.

Information stored on the machine-readable memory may pertain to the user. The information may be available to an authorized accessor of the machine-readable memory via a secure communications channel. The information may be restricted from the user's access via a communications channel associated with the user.

The machine-readable memory may be located at a different location than the user.

The machine-readable memory may be located at the same location as the user.

The machine-readable memory may include information that relates to prior user searches. In some embodiments, the machine-readable memory may include personal user information.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

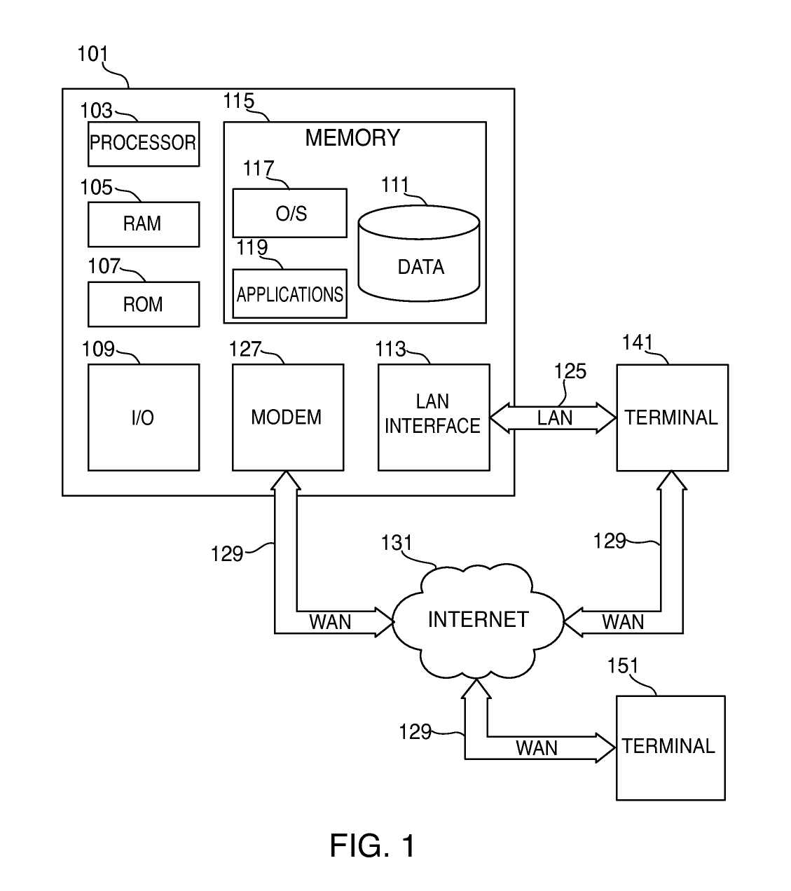

FIG. 1 is an illustrative block diagram of system 100 based on a computer 101. The computer 101 may have a processor 103 for controlling the operation of the device and its associated components, and may include RAM 105, ROM 107, input/output module 109, and a memory 115. The processor 103 will also execute all software running on the computer—e.g., the operating system. Other components commonly used for computers such as EEPROM or Flash memory or any other suitable components may also be part of the computer 101.

The memory 115 may be comprised of any suitable permanent storage technology—e.g., a hard drive. The memory 115 stores software including the operating system 117 any application(s) 119 along with any data 111 needed for the operation of the system 100. Alternatively, some or all of computer executable instructions may be embodied in hardware or firmware (not shown). The computer 101 executes the instructions embodied by the software to perform various functions.

Input/output (“I/O”) module may include connectivity to a microphone, keyboard, touch screen, and/or stylus through which a user of computer 101 may provide input, and may also include one or more speakers for providing audio output and a video display device for providing textual, audiovisual and/or graphical output.

System 100 may be connected to other systems via a LAN interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129, but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program(s) 119, which may be used by computer 101, may include computer executable instructions for invoking user functionality related to communication, such as email, Short Message Service (SMS), and voice input and speech recognition applications.

Computer 101 and/or terminals 141 or 151 may also be devices including various other components, such as a battery, speaker, and antennas (not shown).

Terminal 151 and/or terminal 141 may be portable devices such as a laptop, cell phone, Blackberry™, or any other suitable device for storing, transmitting and/or transporting relevant information. Terminals 151 and/or terminal 141 may be other devices. These devices may be identical to system 100 or different. The differences may be related to hardware components and/or software components.

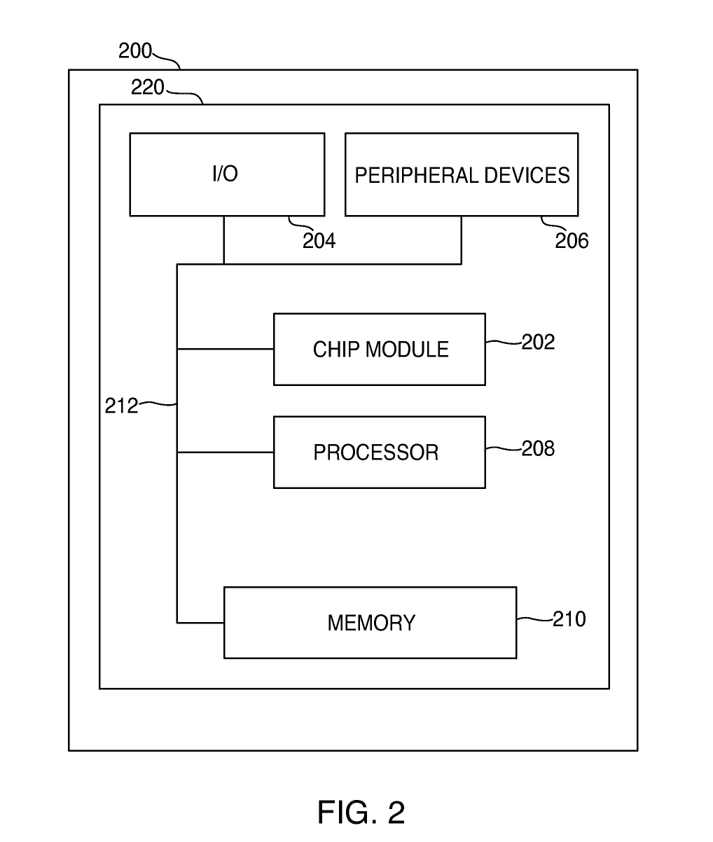

FIG. 2 shows illustrative apparatus 200. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device 208, which may compute data structural information, structural parameters of the data, predict possible queries and machine-readable memory 210.

Machine-readable memory 210 may be configured to store in machine-readable data structures: information pertaining to a merchant, information pertaining to MCC(s) which have been assigned to the merchant, goods and/or services offered by the merchant, historical information pertaining to historical user searches and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

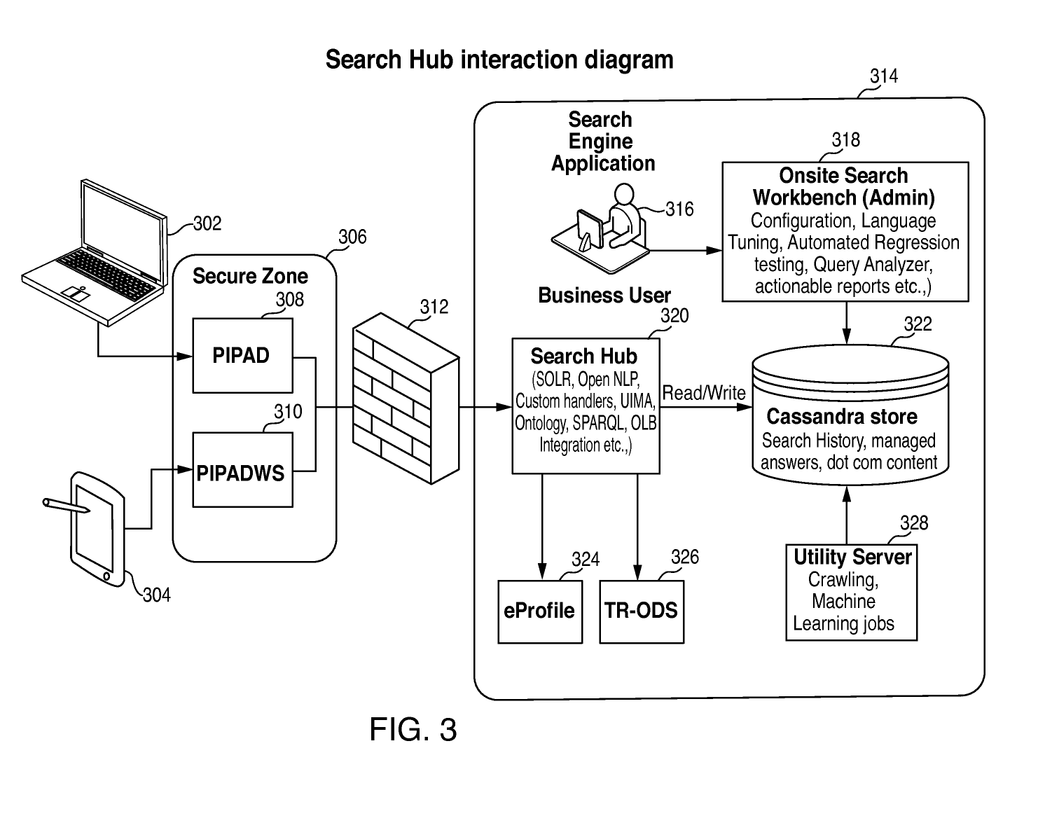

FIG. 3 shows an illustrative hybrid apparatus/flow diagram according to certain embodiments. At laptop computer 302 and/or tablet computer 304, FIG. 3 shows a user initiating a query. Initiation of a query may include a letter, a word, a phrase or other information that indicates that the user has expressed interest in obtaining information in response to a preferably user-defined query.

Preferably, the query must first pass through a secure zone 306 prior to traversing firewall 312. Secure zone preferably includes PIPAD 308 for providing a path for query initiation generated by laptop computers 302 and PIPADWS 310 for providing a path for query initiation generated by tablet computers 304.

Upon successful traverse of secure zone 306 and firewall 312, the initiation of the query may enter a search engine application 314.

The search engine application 314 may, in certain embodiments, receive the user's search initiation at search hub 320. Search hub 320 may include a number of open source searching applications.

Certain open source search applications, and other applications, included in search hub 320, and general searching according to the invention, may preferably include applications such as SOLR, Open NLP, UIMA, SPARQL, among others.

SOLR is an open source search application that provides, inter alia, distributed indexing, replication and load-balanced querying, automated failover and recovery as well as centralized configuration.

The most common OpenNLP tasks include tokenization, sentence segmentation, part-of-speech tagging, named entity extraction, chunking, parsing, and coreference resolution. These tasks are usually required to build more advanced text processing services. OpenNLP also includes maximum entropy and perception-based machine learning.

UIMA is the acronym for Unstructured Information Management Applications. These applications are software systems that analyze large volumes of unstructured information in order to discover knowledge that is relevant to an end user. An exemplary UIM application may receive plain text and identify entities, such as persons, places, organizations in response to the received plain text; or relations, such as works-for or located-at.

UIMA enables applications to be decomposed into components, for example “language identification”=>“language specific segmentation”=>“sentence boundary detection”=>“entity detection (person/place names etc.)”. Each component implements interfaces defined by the framework and provides self-describing metadata via XML descriptor files. The framework manages these components and the data flow between them. Components are typically written in Java TM or C++; the data that flows between components is designed for efficient mapping between these languages.

UIMA additionally provides capabilities to wrap components as network services, and can scale to very large volumes by replicating processing pipelines over a cluster of networked nodes.

SPARQL, in one aspect, is a query language. SPARQL is “data-oriented” in that it only queries the information held in the models. There is preferably no inference in the query language itself. SPARQL preferably takes the description of what the application wants, in the form of a query, and returns that information. In the particular embodiments described herein, SPARQL may serve to retrieve information in response to a completed and/or potential query.

Other aspects of search hub 320 may include customer ontology, which relates to usage of words as retrieved from historical user queries, among others, custom handlers and Online Banking (“OLB”) integration.

Some embodiments enable search hub 320 to access eProfile 324. eProfile 324 may include information relating to the user's accounts, personal information, behavior, prior searches, history and any other stored information that may be relevant to a user. In certain embodiments, such information may be accessible exclusively by search hub 320. In certain embodiments, such information may be accessible by the user. In certain embodiments, such information may be accessible exclusively by business user 316.

Search hub may also be coupled to TR_ODS which is an acronym for transactional operational data store. TR-ODS 326 may be understood to be a type of database that serves as an interim area for a data warehouse in order to store time-sensitive operational data that can be accessed quickly and efficiently. In contrast to a data warehouse, which contains large amounts of static data, an ODS contains small amounts of information that is preferably dynamic and may be updated through the course of business transactions.

In some embodiments, TR-ODS 326 may perform numerous quick and simple queries on small amounts of data, such as acquiring an account balance or finding the status of a customer order, whereas a data warehouse may perform complex queries on large amounts of data. An ODS may contain only current operational data while a data warehouse contains both current and historical data.

In conjunction with utilizing the various search software applications, search hub 320 may read and/or write to Cassandra Store 322. Cassandra 322 is an open source distributed database management system designed to handle large amounts of data across many servers. Cassandra preferably provides high availability with no single point of failure.

Cassandra 322 may include, for example, previous user search history, managed answers and/or broadly-based dot.com content.

Cassandra 322 may also be coupled to receive input from a business user via an onsite workbench 318 (administered by an entity-local admin.) Such a workbench may preferably enable configuration of the various elements of search engine application 314, language tuning for the elements that relate to ontology, query parsing, auto-complete tuning, automated regression testing, query analysis, actionable reports, etc.

Also, Cassandra 322 is preferably coupled to utility server 328. Utility server 328 preferably supports Cassandra 322 by providing web-crawling for certain queries, and adding machine learning where necessary for certain queries.

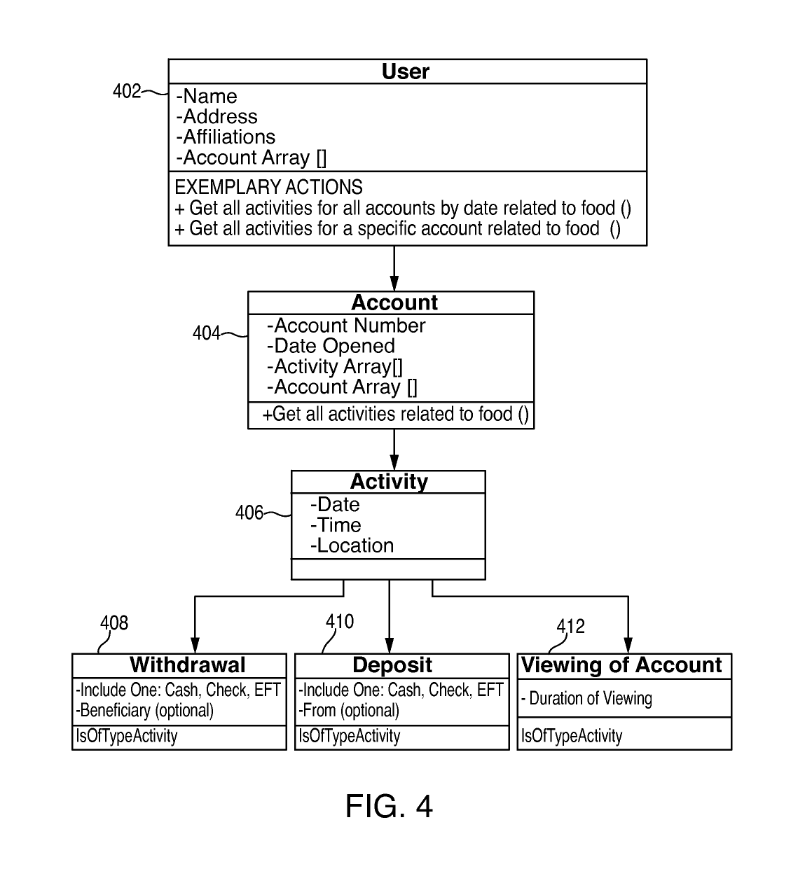

FIG. 4 shows a unified modeling language (“UML”) visualization of embodiments according to the invention. At 402, the user's identification information is depicted. For example, the user's name is shown, along with the user's address, affiliations and account array (including a searchable list of the user's accounts).

Exemplary actions are also shown at 402. The exemplary actions may include queries directed to “get all activities for all accounts by date related to food”, “get all activities for a specific account related to food”, add an account(not shown), add an activity (which may be user enable) (not shown), and view a user account(not shown).

At 404, specific account information is shown. Such specific account information may be retrieved in response to a query processed by the user identified at step 402. Such information may include account number, date opened, activity array and/or additional accounts array. One exemplary action that is shown at 404 is to “get all activities related to food.”

In response to a get activity query, activity 406 may preferably identify a date, time and/or location of such an activity. Such an activity may be further characterized as a withdrawal as shown at 408, a deposit at 410 and/or a viewing of account 412.

The withdrawal at 408 may preferably include a determination as to whether the activity includes a cash withdrawal, a check withdrawal or an electronic funds transfer (“EFT”). The beneficiary of the withdrawal may also be included (optional).

The deposit at 410 may preferably include a determination as to whether the activity includes a cash deposit, a check deposit and/or an EFT deposit.

The viewing of account at 412 may include a duration of viewing.

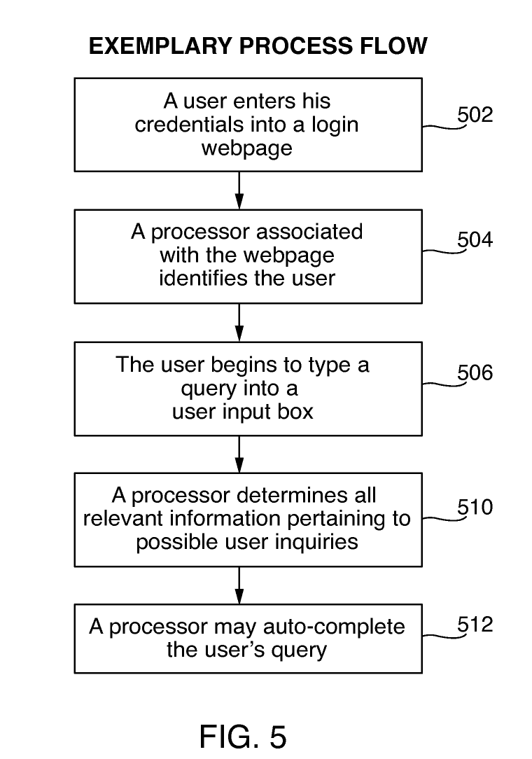

FIG. 5 shows an illustrative flow diagram according to some embodiments. Step 502 shows a user entering his or her credentials into a login webpage.

Step 504 shows that a processor associated with the webpage may identify the user. The user may, at step 506, initiate a query by beginning to type a query into a user input box.

At step 510, a processor may determine (and retrieve) relevant information pertaining to possible user inquiries. The relevant information may include information that is only available from a user-inaccessible storage location. The relevant information may include information that is only available from a remote, with respect to the user, storage location. The relevant information may include information that is only available from a storage location that is only accessible in response to the user inputting user credentials.

It should be noted that, while step 510 may, in one embodiment, be understood to include determining (and retrieving) relevant information that is only available from a storage location that is only accessible in response to the user inputting user credentials, nevertheless the scope of the embodiments are not necessarily limited to only such embodiments. Rather, embodiments may also include determining (and retrieving) information from sources other than sources that contain information that is only available from a storage location that is only accessible in response to the user inputting user credentials. For example, embodiments may also include determining (and retrieving) information from sources that include statistics of all users' previous queries along with the contexts of such queries.

Based on the retrieval shown in step 510, and relevant predictive algorithm, step 512 shows that the processor may auto-complete the user's inquiry. The inquiry may require user confirmation in order to execute and retrieve documents.

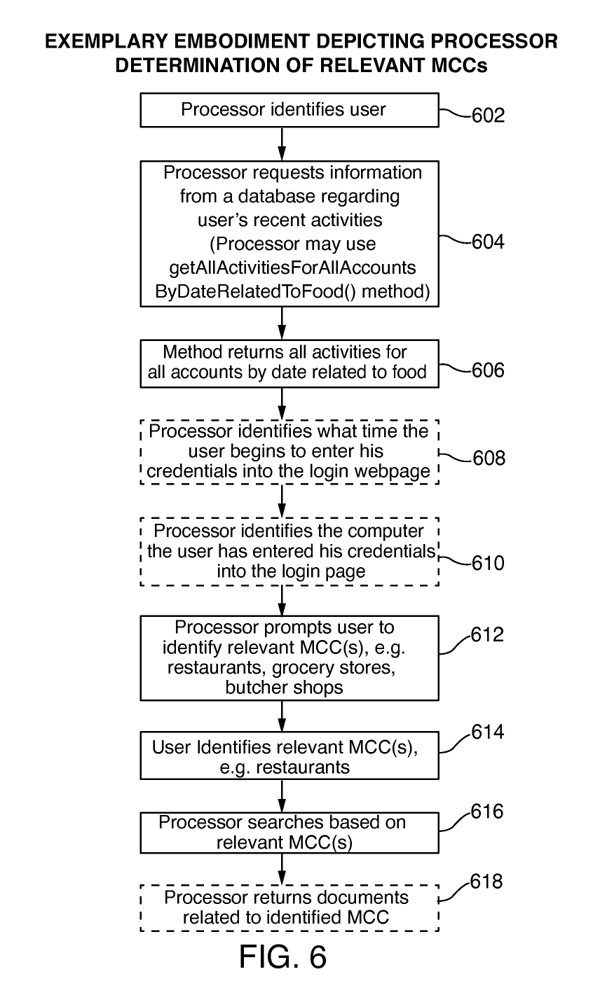

FIG. 6 shows another illustrative flow diagram depicting certain methods according to the invention. Step 602 shows a processor identifying user. Such identification may preferably be obtained in response to a user entering credentials.

Step 604 shows a processor requesting information from a database regarding the user's recent activities. In one exemplary embodiment of such an algorithmic step, the processor may utilize a get_All_Activities_For_All_Accounts_By_Date_related_to_food( ) step for obtaining information related to the user's recent activities related to food.

Such a method may preferably return all activities related to food for all accounts by date—e.g. by a specific date, as shown in step 606. In yet another exemplary algorithmic step, the processor may identify what time the user began to enter his credentials, as shown in step 608. It should be noted that step 608, as well as steps 610, 618 and 702-706 are surrounded in dotted line. The dotted line indicates that, for certain embodiments, such steps may preferably be optional steps and not required by methods or apparatus according to the system.

In yet another exemplary algorithmic step, the processor may identify at what computer the user entered his credentials, as shown in step 610. In yet another exemplary algorithmic step, the processor may prompte the user to identify MCCs, such as restaurants, grocery stores and/or butcher shops, relevant to his search, as shown in step 612.

Step 614 shows that the user identifies a preferably most relevant MCCs—e.g., restaurants. It should be noted that user self-identification of MCC may preferably enable the apparatus, method or system to further narrow the search and produce more targeted search results. For example, when the user was searching through his food spending for a predetermined period of time, and the user further identified the area of spending he was most interested in—e.g., restaurant spending—the system may preferably return targeted transactions for the pre-determined time period. Such a system may preferably increase searching efficiency and reduce user frustration at a large number of irrelevant results, or an overly-inclusive search.

Following retrieval of some or all of the foregoing information, the processor may search as shown in step 616.

The processor may return documents related to identified MCC, as shown in step 618.

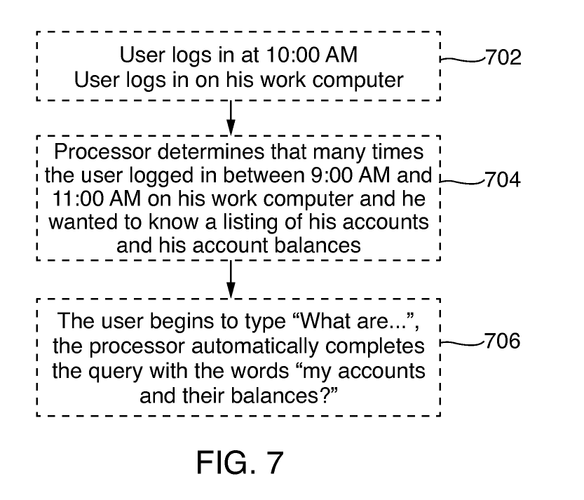

FIG. 7 shows yet another example of an illustrative flow diagram according to the invention. Specifically, the flow diagram illustrates an exemplary algorithm according to certain embodiments.

Step 702 shows a user logging in at 10:00 AM. Step 702 also shows that the user is logging in to his work computer.

Step 704 shows that, based on step 702, the processor determines that many times the user logged in between 9:00 AM and 11:00 AM on his work computer. When he logged in during this time window from his work computer, he often indicated an interest in reviewing a listing of his accounts and/or his account balances.

Step 706 shows that the user initiates the query by typing “what are . . . ” At this point, step 706 shows that the processor auto-completes the query with the words, “my accounts and their balances?”

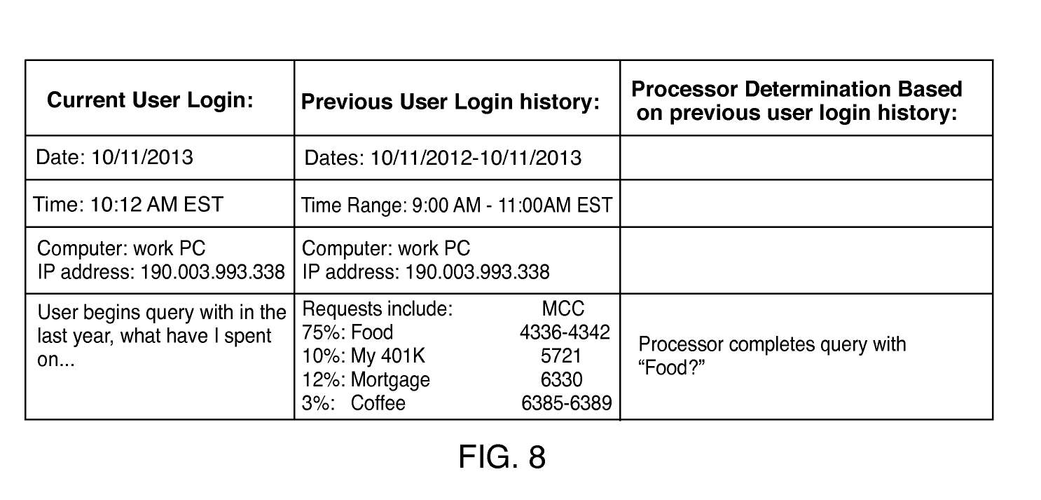

FIG. 8 shows an illustrative chart showing additional detail for understanding the information set forth in FIG. 7. “Current user login” column preferably sets forth the date, time, IP address and initial query of the user's login.

“Previous user login history” sets forth a statistical rendering of the user's login history over the dates 10/11/2012 to 10/11/2013.

“Processor Determination Based on previous user login history:” sets forth an auto-complete option based on a prediction. The prediction preferably takes into account the information included in “Current user login” and “Previous user login.”

Thus, methods and apparatus for performing natural language searching based on MCCs are provided. Persons skilled in the art will appreciate that the present invention can be practiced by other than the described embodiments, which are presented for purposes of illustration rather than of limitation, and that the present invention is limited only by the claims that follow.

What is claimed is:

1. An apparatus for executing a search based on merchant category codes (“MCC”), the apparatus comprising:
a webpage, the webpage comprising:
a search box, the search box comprising:
a user input field;
a processor;
machine-readable memory;
wherein, when a user types a query into the user input field, the processor is configured to:
identify an MCC with greater than a threshold level of correlation to the user's query;
in response to identifying the MCC, search the machine-readable memory for documents pertaining to the MCC and pertaining to the user's query; and,
wherein the processor is further configured to:
provide a set of documents that respond to the user's query; and
provide a reciprocal query to the user, said reciprocal query for obtaining a greater quantum of MCC information then was included in the user's query.

2. The apparatus of claim 1, wherein information stored on the machine-readable memory pertains to the user, wherein the information is available to an authorized accessor of the machine-readable memory via a secure communications channel, but the information is restricted from the user's access via a communications channel associated with the user.

3. The apparatus of claim 1, wherein the reciprocal query identifies a plurality of MCCs, each of the MCCs including greater than a threshold level of correlation to the identified MCC.

4. The apparatus of claim 1, wherein the identified MCC is one of a group of MCCs having greater than a threshold correlation to prior user searches.

5. The apparatus of claim 1, wherein the machine-readable information comprises confidential user information.

6. The apparatus of claim 1, wherein the information is stored on a cookie on the machine-readable memory.

7. The apparatus of claim 1, wherein the reciprocal query provides a plurality of MCCs to the user, or subject matter corresponding thereto, and prompts the user to identify a one or more MCCs corresponding to the user's query.

8. An apparatus for executing a search based on merchant category codes (“MCC”) codes, the apparatus comprising:
a webpage, the webpage comprising:
a search box, the search box comprising:
a user input field;
a processor;
machine-readable memory;
wherein, when a user types a query into the user input field, the processor is configured to:
identify a subject matter area, said subject matter area which correlates to a plurality of MCCs at a greater than threshold level of correlation;
in response to identifying the subject matter area, search the machine-readable memory for documents pertaining to the subject matter area and pertaining to the user's query, and provide a set of documents that respond to the user's query;
transmit a reciprocal query to the user, said reciprocal query that provides the plurality of MCCs, or subject matter corresponding thereto, in order to prompt the user to identify a single MCC corresponding to the user's query.

9. The apparatus of claim 8 wherein information stored on the machine-readable memory pertains to the user, wherein the information is available to an authorized accessor of the machine-readable memory via a secure communications channel, but the information is restricted from the user's access via a communications channel associated with the user.

10. The apparatus of claim 8 wherein the machine-readable memory is located at a different location than the user.

11. The apparatus of claim 8, wherein the machine-readable memory is located at the same location as the user.

12. The apparatus of claim 8, wherein the information comprises prior user searches.

13. The apparatus of claim 8, wherein the information comprises personal user information.

14. One or more non-transitory computer-readable media storing computer-executable instructions which, when executed by a processor on a computer system, performs a method for executing a search based on merchant category codes (“MCC”) codes, the method comprising:
providing a webpage comprising a search box, the search box comprising a user input field;
in response to receipt of a user query into the user input field, using a processor to:
identify a subject matter area, said subject matter area which correlates to a plurality of MCCs at a greater than threshold level of correlation;
in response to identifying the subject matter area, search a machine-readable memory for documents pertaining to the subject matter area and pertaining to the user's query; and
provide a set of documents that respond to the user's query.

15. The method of claim 14, the method further comprising prompting the user to identify a single MCC from among the plurality of MCCs, the single MCC corresponding to the user's query, the prompting comprising using the processor to provide a reciprocal query to the user, said reciprocal query that provides the plurality of MCCs, or subject matter corresponding to the plurality of MCCs.

16. The apparatus of claim 14 wherein information stored on the machine-readable memory pertains to the user, wherein the information is available to an authorized accessor of the machine-readable memory via a secure communications channel, but the information is restricted from the user's access via a communications channel associated with the user.

17. The apparatus of claim 14 wherein the reciprocal query identifies a plurality of MCCs, each of the plurality of MCCs including greater than a threshold level of correlation to the identified subject matter area.

18. The apparatus of claim 14, wherein the information comprises prior user searches.

19. The apparatus of claim 14, wherein the information comprises personal user information.
